(19) United States
(12) Patent Application Publication
(10) Pub. No.: US 2014/0128657 A1
(43) Pub. Date: May 8, 2014

(54) PROCESSING OF ELECTRONIC WASTE WITH SUPERCRITICAL NOBLE GASES

(71) Applicant: Empire Technology Development LLC, Wilmington, DE (US)

(72) Inventors: William B. CARLSON, Seattle, WA (US); Gregory D. PHELAN, Cortland, NY (US)

(73) Assignee: Empire Technology Development LLC, Wilmington, DE (US)

(21) Appl. No.: 13/964,840

(22) Filed: Aug. 12, 2013

(30) Foreign Application Priority Data
Nov. 2, 2012 (US) PCT/US2012/063217

(51) Int. Cl. A62D 3/00

(52) U.S. Cl. CPC A62D 3/00
USPC 588/313

(57) ABSTRACT

A method of processing a material, the method including infiltrating a first disintegration fluid into a material at a first pressure, the first disintegration fluid including at least one supercritical noble gas, the first pressure being higher than a critical pressure of the first disintegration fluid, and disintegrating the material into particles by depressurizing the material from the first pressure to a second pressure, the second pressure being lower than the critical pressure of the first disintegration fluid.

### FIELD

This technology generally relates to the processing of materials and, more particularly, to processing electronic waste using supercritical noble gasses.

### BACKGROUND

An unintended consequence of the information technology revolution is a new and potentially toxic waste stream. Some estimates suggest that 100 million personal computers are discarded every year, worldwide. In the United States, this amounts to about two million tons of computer-related waste per year. The European Union has identified waste electrical and electronic equipment as a fast-growing waste stream, amounting to about five percent of the municipal solid waste and growing at about three times the rate of the total municipal solid waste stream.

Historically, durable electronic goods such as televisions, radios, and stereos entered the waste stream about five to twenty years after the goods were purchased. Today, items with logic, memory, and complex printed circuit boards enter the waste stream much sooner. For example, in many countries, a three-year-old mobile phone, portable music player, or gaming console is considered out of date and thus enters the waste stream.

Whereas waste entering the municipal solid waste stream normally includes simple materials typically necessitating only a limited number of disposal steps, management of electronic waste is much more complex. Waste electrical and electronic equipment contains useful materials, such as recyclable metals, glasses, and plastics, as well as valuable metals, such as gold, copper, nickel, palladium, silver, and/or zinc. Further, waste electrical and electronic equipment contain potentially hazardous materials, such as toxic metals (e.g., lead, mercury, chromium, and/or cadmium), toxic organic compounds, and/or toxic inorganic compounds. As a result, it is advantageous to process waste electrical and electronic equipment using reclamation and/or recycling processes.

### SUMMARY

In one aspect, a method is provided for processing a material. In many embodiments, the method includes infiltrating a first disintegration fluid into a material at a first pressure and/or disintegrating the material into particles by depressurizing the material from the first pressure to a second pressure. The first disintegration fluid may include at least one supercritical noble gas. The first pressure may be higher than a critical pressure of the first disintegration fluid. The second pressure may be lower than the critical pressure of the first disintegration fluid.

In embodiments, the method includes providing particles of a material that includes a polymer, applying a decomposition fluid to the particles, and at least partially decomposing the polymer by subjecting the particles and/or the decomposition fluid to a heating condition. The decomposition fluid may include at least one supercritical noble gas and at least one additive.

In any of the above embodiments, the method may include exposing a material in a disintegration vessel to a first disintegration fluid (which may include supercritical argon) at a first pressure (which may be higher than a critical pressure of the disintegration fluid), disintegrating the material into particles by depressurizing the disintegration vessel from the first pressure to a second pressure (which may be lower than the critical pressure of the first disintegration fluid), exposing the particles to a decomposition fluid (which may include supercritical argon and at least one additive), and/or heating the particles and/or the decomposition fluid to a temperature sufficient to at least partially decompose a polymer present in at least some of the particles.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of the present disclosure will become more fully apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

FIG. 1 is a process diagram of a method of processing a material, according to one embodiment.

FIG. 2 is a process diagram of a method of processing a material, according to one embodiment.

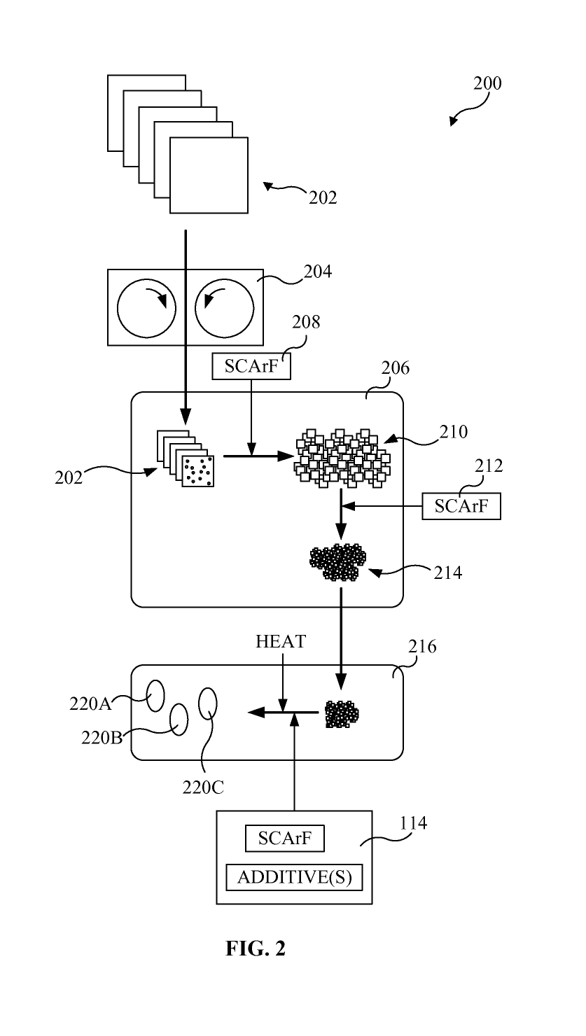

FIG. 3 is a flow chart illustrating an example method of processing a material, according to one embodiment.

FIG. 4 is a flow chart illustrating an example method of processing a material, according to one embodiment.

FIG. 5 is a flow chart illustrating an example method of processing a material, according to one embodiment.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Methods, systems, devices, and/or apparatuses related to processing materials are described. In one aspect, a method is provided for processing materials, such as electronic waste, using supercritical noble gasses. In the methods, the supercritical noble gas fluid penetrates the void spaces of materials and upon release of pressure causes disintegration of the materials. The supercritical noble gas fluid chemically breaks the materials into their respective constituent molecules and/or elements.

The methods employ supercritical noble gas fluid to process waste streams from semiconductor and electronics industries. For example, the methods may be used to treat waste electrical and electronic equipment.

The supercritical noble gas fluid is used to physically break down (e.g., pulverize) electronic waste, such as through a high-pressure/low-pressure cycle. The supercritical noble gas fluid may also be used as a medium in which individual components of a waste stream may be separated, or as a medium in which components of a waste stream are chemically broken down.

Noble gasses are a series of gasses that have their outer shell of valence electrons completely filled, and, as such, are substantially inert to chemical reactions. Naturally occurring noble gasses include helium, neon, argon, krypton, and xenon, any of which may be used in the above methods. The noble gasses generally do not support combustion and are non-toxic. Argon is common in Earth's atmosphere. Argon constitutes about 1.28% of Earth's atmosphere, making it about 33 times more common than atmospheric carbon dioxide. Argon and other noble gasses are obtained by liquefaction of the atmosphere followed by distillation to yield the respective noble gas.

Supercritical Argon fluid (SCArF) is substantially inert and nonreactive with water and materials from which electrical and electronic devices are constructed (e.g., metals, ceramics, pigments, amines, sulfur, alcohols, etc.). Although certain embodiments are described herein in connection with the method, other noble gasses and/or mixtures of noble gasses can be used in substantially the same manner.

The terms “critical pressure”, “critical temperature,” and “critical point” are well known by a person having ordinary skill in the art. In general, a substance's critical pressure is the pressure above which distinct liquid and gas phases substantially do not exist when the substance is at that substance's critical temperature. Together, a substance's critical temperature and critical pressure is referred to as the substance's “critical point.” Critical points for various substances can be easily found in technical reference materials. For example, for argon the critical pressure is about 50 atm at a critical temperature of about −122° C. As another example, xenon's critical point is about 17° C. at about 60 atm. As used herein, “supercritical fluid” refers to the state of a substance above its critical temperature and its critical pressure. At temperatures between about 25° C. and about 150° C., supercritical pressures for argon are about 300 atm to about 500 atm. For xenon, supercritical pressures for xenon at the same temperature are about 75 atm to about 250 atm.

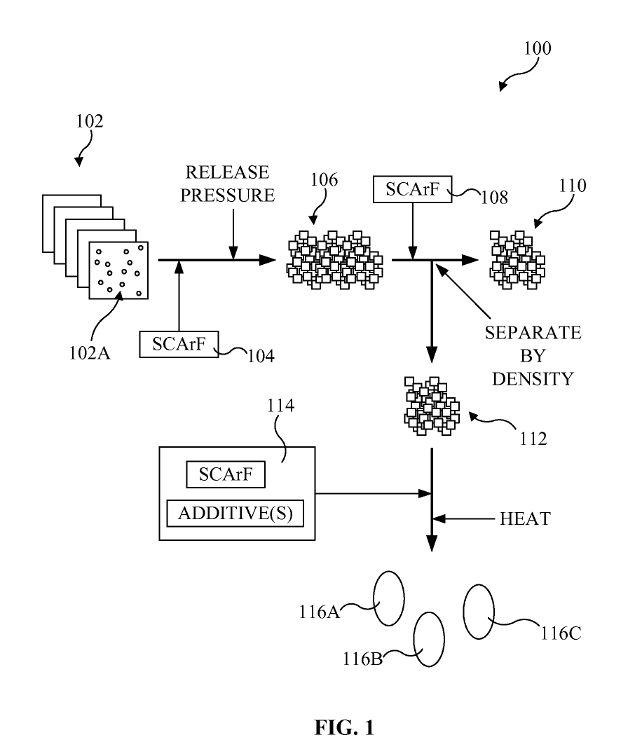

FIG. 1 is a process diagram of an example method 100 of processing a material 102 using SCArF. Material 102, which may include waste electrical or electronic equipment, may be contacted with a disintegration fluid 104 (e.g., including SCArF) at a first pressure. For example, material 102 may be soaked in disintegration fluid 104 for generally any length of time. Soaking times include about 1 minute to about 3 minutes, about 1 minute to about 60 minutes, or about 1 minute to about 120 minutes. Specific examples of soaking times include about 1 minute, about 3 minutes, about 5 minutes, about 10 minutes, about 15 minutes, about 30 minutes, about 45 minutes, about 60 minutes, about 90 minutes, about 120 minutes, and ranges between any two of these values or above any one of these values. The first pressure may be higher than a critical pressure of disintegration fluid 104. Disintegration fluid 104 may infiltrate one or more voids 102A of material 102. For example, in a printed circuit board, disintegration fluid 104 may accumulate in void spaces of processors, chips, and between layers of the circuit board. Material 102 may be depressurized from the first pressure to a second pressure lower than the critical pressure of disintegration fluid 104, which may allow disintegration fluid 104 within voids 102A to expand, which may break apart material 102 into a plurality of particles 106.

In some embodiments, an average size of particles 106 may be about 10 nm to about 2 mm. In other embodiments, an average size of particles 106 may be about 100 nm to about 1 mm. Specific examples of average particle size include about 10 nm, about 100 nm, about 1,000 nm, about 10,000 nm, about 1 mm, and ranges between any two of these values or above any one of these values.

As illustrated in FIG. 1, particles 106 may be separated based on physical properties and/or by density, among other characteristics. For example, SCArF 108 may be added to particles 106. Higher density particles including a first portion, such as metals 110, may be separated from lower density particles including a second portion, such as one or more polymers 112. Example polymers 112 include, without limitation, epoxy resins, polycarbonate, and/or nylon.

In embodiments, a decomposition fluid may include SCArF and/or one or more additives, may be applied to polymers 112. Example additives may include, but are not limited to, one or more of water, oxygen, fluorine, chlorine, sodium carbonate, ammonia (NH₃ or NH₄OH), urea (CO(NH₂)₂), an acid, a base, an ionic liquid, and C₁₋₁₂ alcohols. The alcohols may be primary, secondary, or tertiary alcohols. Illustrative alcohols include, but are not limited to methanol, ethanol, n-propanol, isopropyl alcohol, n-butanol, isobutanol, and tert-butanol. Other alcohols include pentanol, hexanol, heptanol, octanol, nonanol, decanol, undecanol and dodecanol, and isomers thereof. Heat may be applied to polymers 112 and/or decomposition fluid 114. For example, polymers 112 and/or decomposition fluid 114 may be subjected to a heating condition of about 100° C. to about 500° C. Specific examples of temperatures include about 100° C., about 150° C., about 200° C., about 250° C., about 300° C., about 350° C., about 400° C., about 450° C., and about 500° C. Polymers 112 may be at least partially decomposed into components 116A, 116B, 116C, which may be reused and/or recycled.

Material 202 may be mechanically pulverized (e.g., using a pulverizer 204) prior to processing using SCArF. Material 202 may be placed in a disintegration vessel 206, where it may be exposed to a first disintegration fluid 208 (e.g., SCArF) at a first pressure. The first pressure may be higher than a critical pressure of the first disintegration fluid 208. Material 202 may be disintegrated into particles 210 by depressurizing disintegration vessel 206 from the first pressure to a second pressure lower than the critical pressure of disintegration fluid 208.

In embodiments, particles 210 may be exposed to a second disintegration fluid 212 at a third pressure. The third pressure may be higher than a critical pressure of second disintegration fluid 212. Particles 210 may be disintegrated into sub-particles 214 by depressurizing disintegration vessel 206 from the third pressure to a fourth pressure lower than the critical pressure of second disintegration fluid 212. In some embodiments, first disintegration fluid 208 and second disintegration fluid 212 may have substantially the same composition and/or may have substantially the same critical pressure. In some embodiments, the first pressure and the third pressure may be substantially the same. In some embodiments, the second pressure and the fourth pressure may be substantially the same.

At least some of particles 210 and/or at least some of sub-particles 214 may be transferred from disintegration vessel 206 to a decomposition vessel 216. A decomposition fluid 218, which may include SCArF, and/or one or more additives, and/or a heating condition may be applied. Polymers may be at least partially decomposed into components 220A, 220B, 220C, which may be reused and/or recycled.

In many embodiments, the method incorporates reaction conditions configured to obtain desired constituent components from polymer decompositions. Additives can be included, heating conditions can be adjusted, and/or reaction conditions are tuned by limiting certain species in the conditions to stop the process at desired points. Additives include various compounds, acids, bases, ionic liquids, oxidants, and reductants. Oxygen, fluorine, chlorine, and other oxidants can be added to aid in the treatment of electronic waste by supercritical noble gas fluids. Acids, bases, and ionic liquids can be included to provide the necessary constituent chemicals. Depending on the composition of the materials, the additives can be varied to enhance the production of one set of decomposition products over other possible decomposition products.

The method may include processing polycarbonates. Polycarbonates are used in the manufacture of electrical equipment, such as printed circuit boards. Scheme 1 illustrates several decomposition products that can occur by utilizing the method with bisphenol-A-based polycarbonates. Bisphenol-A-based polycarbonates are an example where the additives can be varied to enhance the production of one set of decomposition products over another set of decomposition products. Processing of bisphenol-A-based polycarbonates with Na₂CO₃ and water favors phenol formation. This preference can be switched by utilizing NH₄OH and water or urea and water to favor bisphenol A formation. This preferential formation illustrates the versatility of the method in generating desired product streams.

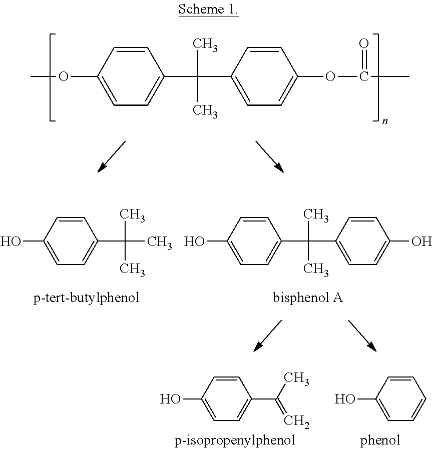

In some embodiments, the method includes processing epoxy resins. Epoxy resins are used in motherboard construction. For example, a variety of motherboards are constructed by laminating cotton paper soaked with epoxy. Resin systems for such applications include brominated diglycidyl ether of bisphenol A and are cured with polyamine-fatty polyamide mixtures.

The method may also include processing nylon. Nylon is another material commonly used in printed circuit boards. For example, supports, spacers, and/or other structural parts of motherboards may be made of nylon. Processing of nylon-6 via the supercritical noble gas method can liberate 6-amino caproic acid, as shown in Scheme 2. Furthermore, utilizing the right set of conditions can yield c-caprolactam directly from the polymer. This is yet another illustration of the versatility of the supercritical noble gas method.

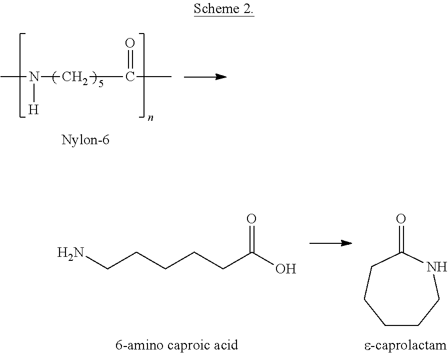

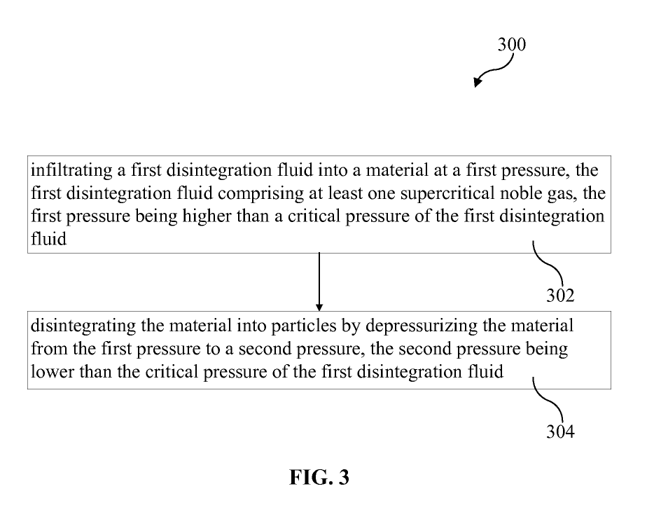

FIG. 3 is a flow chart illustrating an example method 300 of processing a material. Method 300 may include operation 302, which may include infiltrating a first disintegration fluid into a material at a first pressure. The first disintegration fluid may include at least one supercritical noble gas. The first pressure may be higher than a critical pressure of the first disintegration fluid. Operation 302 may be followed by operation 304, which may include disintegrating the material into particles by depressurizing the material from the first pressure to a second pressure. The second pressure may be lower than the critical pressure of the first disintegration fluid.

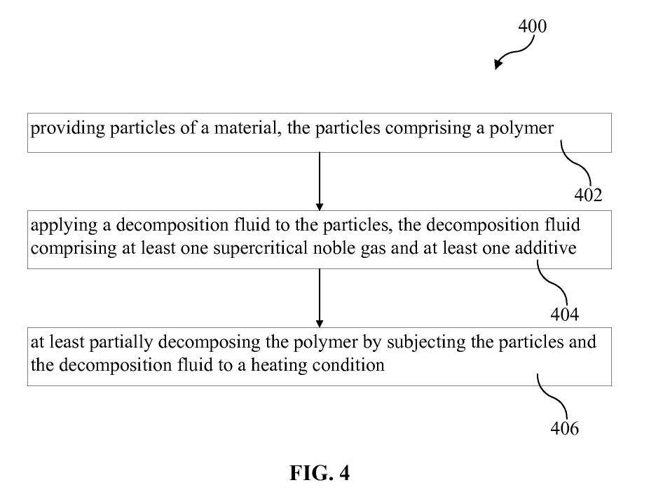

FIG. 4 is a flow chart illustrating an example method 400 of processing a material. Method 400 may include operation 402, which may include providing particles of a material, the particles including a polymer. Operation 402 may be followed by operation 404, which may include applying a decomposition fluid to the particles, the decomposition fluid including at least one supercritical noble gas and at least one additive. Operation 404 may be followed by operation 406, which may include at least partially decomposing the polymer by subjecting the particles and the decomposition fluid to a heating condition.

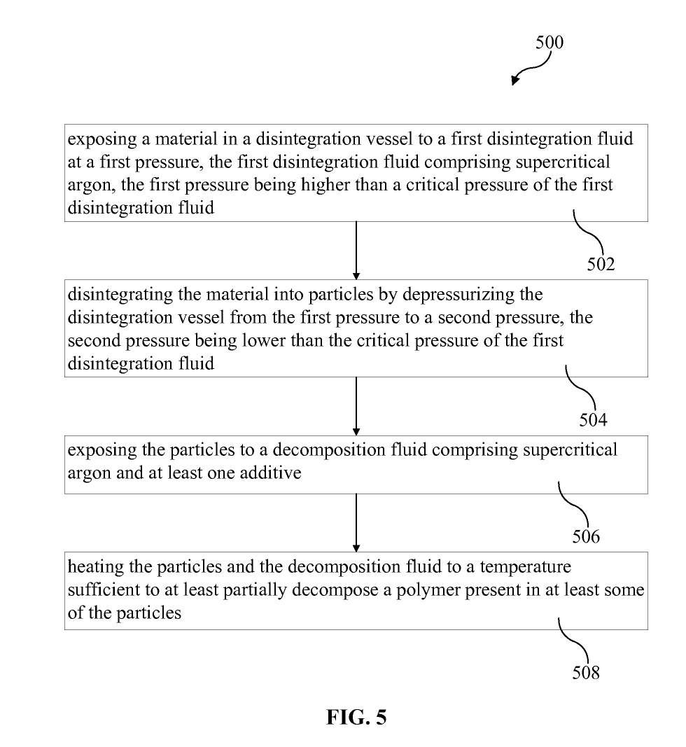

FIG. 5 is a flow chart illustrating an example method 500 of processing a material. Method 500 may include operation 502, which may include exposing a material in a disintegration vessel to a first disintegration fluid at a first pressure. The first disintegration fluid may include supercritical argon. The first pressure may be higher than a critical pressure of the first disintegration fluid. Operation 502 may be followed by operation 504, which may include disintegrating the material into particles by depressurizing the disintegration vessel from the first pressure to a second pressure. The second pressure may be lower than the critical pressure of the first disintegration fluid. Operation 504 may be followed by operation 506, which may include exposing the particles to a decomposition fluid including supercritical argon and at least one additive. Operation 506 may be followed by operation 508, which may include heating the particles and the decomposition fluid to a temperature sufficient to at least partially decompose a polymer present in at least some of the particles.

The present technology, thus generally described, will be understood more readily by reference to the following examples, which are provided by way of illustration and are not intended to be limiting.

### EXAMPLES

The following non-limiting examples depict the synthesis and generation of certain embodiments of the current technology.

### Example 1

Epoxy resin processing by a SCArF method. A 1 L SCArF reactor is loaded with SCArF and 10 g epoxy resin. To the reactor is then added a stoichiometric amount of water and heated to a working temperature between 200° C. and 410° C. Upon reaching the working temperature, a stoichiometric amount of oxygen in SCArF is introduced. The reaction is allowed to go to completion. Upon cooling and release of argon gas, the constituent products are expected to be reclaimed.

### Example 2

Polycarbonate processing by a SCArF method with water and Na₂CO₃ additives. To a 100 mL tubular bomb reactor is added 1 g of pulverized bisphenol A polycarbonate, 0.20 g water, 0.15 g Na₂CO₃, and 20 mL of SCArF. The reactor is then heated to 300° C. at a rate of 10° C./minute, and the reaction allowed to proceed for 10 hours at 300° C. Upon cooling and depressurizing, the reaction products are extracted by ether. Total yield of the decomposition is expected to be 60% by weight, with 47.5% by weight of phenol.

### Example 3

Polycarbonate processing by a SCArF method with water and NH₄OH additives. To a 100 mL tubular bomb reactor is added 1 g of pulverized bisphenol A polycarbonate, 0.11 g 25% (w/w) NH₄OH and 20 mL of SCArF. The reactor is then heated to 300° C. at a rate of 10° C./minute, and the reaction allowed to proceed for 10 hours at 300° C. Upon cooling and depressurizing, the reaction products are extracted by ether. In comparing to Example 2, the yield of bisphenol A is expected to be larger than the yield of phenol.

In Examples 2 and 3, it is also expected that acidic additives have no effect on the polycarbonate decomposition. It was also expected that without additives the decomposition reaction of polycarbonate in water scarcely occurs at 250° C. for 1 hour.

### Example 4

Nylon processing by a SCArF method. To a 100 mL tubular bomb reactor is added 1 g of pulverized nylon-6, 2.0 mL isopropanol and 20 mL of SCArF. The reaction is allowed to proceed at 370° C. for 1.5 hours and is expected to provide c-caprolactam in greater than 90% yield.

In the above reaction, other secondary and tertiary alcohols are expected to selectively gave c-caprolactam in high yields. Primary alcohols can also be used: methanol is expected to provide ε-caprolactam in 14% yield, ethanol is expected to provide ε-caprolactam in 35% yield, and 1-dodecanol is expected to provide c-caprolactam in 61% yield.

### Example 5

A 2 L supercritical noble gas apparatus: The two liter vessel and lid is made of high density steel 3.5 inches thick. The lid is secured with ten bolts to the vessel and has two valves: one for injecting the supercritical fluid and one for ejecting supercritical fluid. The ejection valve connects to a large tank of 50 L in volume. The large tank is connected to a pump that can bring the 50 L vessel to a vacuum of 1 torr. The injection valve is connected to a supercritical fluid pump

### Example 6

Printed circuit board processing by a SCArF method. A Microsoft® XBox 360® console is disassembled and the printed circuit board is removed. The printed circuit board is observed to have on the surface many chips made by NEC, Motorola, and Taiwan Semiconductor, for example. The printed circuit board is cut into four inch square pieces. The printed circuit board is placed into the two liter vessel of Example 5 and the lid secured. The vessel is pressurized to 2000 psi using an argon tank. Into the vessel is injected 1350 g of supercritical argon at a pressure of roughly 500 atmospheres at an injection rate of 24 mL per second using a SFT-10 Supercritical Fluid Pump (from Supercritical Fluid Technologies, Inc. of Newark, Del.). The system is allowed to sit for 30 minutes after fully pressurized. The ejection valve is opened to the 50 L vessel under vacuum and the system is rapidly brought to equilibrium. The argon can be collected at this time for reuse. The resulting pulverized material is shaken and the dense metals is expected to congregate at the bottom. The lighter polymeric and organic materials are expected to congregate at the top.

### Example 7

Acetone assisted SCArF processing. The same procedure as in Example 6, with the additional step of soaking pieces from the printed circuit board in acetone for about 30 minutes prior to placement in the vessel.

### Example 8

Acid and tetrahydrofuran (THF) assisted SCArF processing. The same procedure as in Example 6, with the additional step of soaking the PCB pieces in a 1:1 (v/v) acetic acid/THF mixture for about 30 minutes prior to placement in the vessel.

### Example 9

Heat assisted pulverization via SCArF. The same procedure as in Example 7, with the additional step of heating the acetone to reflux for 60 minutes. The pieces are removed from the acetone and processed in the same manner as described in Example 6.

### Example 10

Mechanical grinding prior to supercritical noble gas processing. A personal computer console is disassembled and its printed circuit board is removed. The printed circuit board is cut into two inch square pieces. The pieces are ground mechanically and then processed in the same manner as described in Example 6.

### Example 11

Mechanical grinding and acetic acid/acetone pretreatment to improve SCArF processing. A home theatre receiver is disassembled and its printed circuit board is removed. The printed circuit board is cut into one inch square pieces. The pieces from the printed circuit board are ground mechanically and then soaked in an 1:3 (v/v) acetic acid/acetone mixture for 30 minutes. The pieces are then processed in the same manner as described in Example 6.

### Example 12

Repeated applications of SCArF to improve processing. A Microsoft® XBox 360® console is disassembled and the printed circuit board is removed. The printed circuit board is observed to have on the surface many chips made by NEC, Motorola, and Taiwan Semiconductor, for example. The printed circuit board is cut into four inch square pieces. The printed circuit board is placed into the two liter vessel of Example 5 and the lid secured. The vessel is pressurized to 2000 psi using an argon tank. Into the vessel is injected 1500 g of supercritical argon at a pressure of roughly 500 atmospheres at an injection rate of 10 mL per second using the SFT-10 Supercritical Fluid Pump. The system is allowed to sit for 30 minutes after fully pressurized. The ejection valve is opened to the 50 L vessel under vacuum and the system is rapidly brought to equilibrium.

The ejection valve is then closed and the vessel is repressurized to 2000 psi with argon. Into the vessel is injected 1500 g of supercritical argon at a pressure of roughly 500 atmospheres using a supercritical fluid pump set to a 20 mL per second injection rate. The system is allowed to sit for 1.5 hours after fully pressurized. The ejection valve is then opened to the 50 L vessel under vacuum and the system is rapidly brought to equilibrium. The resulting pulverized material is shaken and the dense metals are expected to congregate at the bottom. The lighter polymeric and organic materials are expected to congregate at the top.

### Example 13

Supercritical xenon processing of a cellular phone. An Apple® iPhone® cellular phone is disassembled and its printed circuit board is removed. The cellular phone's integrated display is removed from the printed circuit board. The printed circuit board is placed into the vessel of Example 5. The vessel is pressurized to 1800 psi using a xenon tank. Into the vessel is injected 1000 g of supercritical xenon at a pressure of roughly 150 atmospheres using a supercritical fluid pump set to 20 mL per second injection rate. The system is allowed to sit for 1 hour after fully pressurized. The ejection valve leading is opened to the 50 L vessel under vacuum and the system is rapidly brought to equilibrium. The xenon can be collected at this time for reuse. The resulting pulverized material is shaken and the dense metals are expected to congregate at the bottom. The lighter polymeric and organic materials are expected to congregate at the top.

### Example 14

Mechanical grinding and acetic acid/acetone assisted supercritical xenon processing to reclaim polymer constituents. An LCD television is disassembled and its printed circuit board is removed. The printed circuit board is ground mechanically and then soaked in an 2:1 (v/v) acetic acid/acetone mixture for 60 minutes. The piece is then processed in the same manner as described in Example 13. The process is expected to liberate polymer constituents produced in the polymer degradation by supercritical xenon processing. The polymer constituents are expected to be removed by rinsing the pulverized material with ether, collecting the ether, and then removing the solvent to yield to polymer constituents.

### Example 15

Heat and acetone assisted supercritical xenon processing. An Apple® iPhone® cellular phone is disassembled and its printed circuit board is removed. The cellular phone's integrated display is removed from the printed circuit board. The printed circuit board is soaked in acetone for about 35 minutes. The piece is then heated under reflux in acetone for 60 minutes. The piece is removed from the fluid and then processed in the same manner as described in Example 13.

### Example 16

Supercritical krypton processing of multiple laptop computers using a methanol additive. Ten Dell® laptop computers are disassembled and their printed circuit boards are removed. The printed circuit boards are cut into four inch pieces. The pieces are placed into the vessel of Example 5, with the ejection valve connecting to 100 L tank instead of a 50 L tank. The vessel is pressurized to 1500 psi using a krypton tank. Into the vessel is injected 1700 g of supercritical krypton and 150 g methanol at a pressure of roughly 50 atmospheres using a supercritical fluid pump set to a 28 mL per second injection rate. The system is allowed to sit for 2 hours after fully pressurized. The ejection valve is opened to the 100 L vessel under vacuum and the system is rapidly brought to equilibrium. The krypton can be collected at this time for reuse. The resulting pulverized material is shaken and the dense metals are expected to congregate at the bottom. The lighter polymeric and organic materials are expected to congregate at the top.

### Example 17

Acetone assisted processing utilizing supercritical krypton. Ten Dell® laptop computers are disassembled and their printed circuit boards are removed. The printed circuit boards are then mechanically ground. The ground circuit boards are then soaked in acetone for about 45 minutes. The ground circuit boards are then processed in the same manner as described in Example 16.

### Example 18

Heat and acid assisted processing utilizing supercritical krypton. Ten Dell® laptop computers are disassembled and their printed circuit boards are removed. The printed circuit boards are cut into several one inch pieces. The pieces from the printed circuit board are soaked in an 3:2 (v/v) acetic acid/THF mixture for about 1 hour. The pieces are then heated to a temperature of 52° C. in the mixture for 45 minutes. The pieces are then removed from the fluid and processed in the same manner as described in Example 16.

### Equivalents

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

While certain embodiments have been illustrated and described, it should be understood that changes and modifications can be made therein in accordance with ordinary skill in the art without departing from the technology in its broader aspects as defined in the following claims.

1.-17. (canceled)

18. A method of processing a material, the method comprising:
providing particles of a material, the particles comprising a polymer;
applying a decomposition fluid to the particles, the decomposition fluid comprising at least one supercritical noble gas and at least one additive; and
at least partially decomposing the polymer by subjecting the particles and the decomposition fluid to a heating condition.

19. The method of claim 18, wherein the additive comprises at least one of water, oxygen, sodium carbonate, CH₃CH₂OH, NH₄OH, CO(NH₂)₂, an acid, a base, an ionic liquid, C₁₋₁₂ alcohols.

20. The method of claim 18, wherein the additive comprises at least one of water, oxygen, sodium carbonate, NH₄OH, CO(NH₂)₂, an acid, a base, an ionic liquid, methanol, ethanol, isopropyl alcohol, a C12 alcohol, a secondary alcohol, and a tertiary alcohol.

21. The method of claim 18, wherein providing particles of the material comprises
infiltrating a first disintegration fluid into the material at a first pressure, the first disintegration fluid comprising at least one supercritical noble gas, the first pressure being higher than a critical pressure of the first disintegration fluid; and
disintegrating the material into the particles by depressurizing the material from the first pressure to a second pressure, the second pressure being lower than the critical pressure of the first disintegration fluid.

22. The method of claim 18, wherein the at least one supercritical noble gas comprises supercritical argon.

23. (canceled)

24. The method of claim 18, wherein subjecting the particles and the decomposition fluid to the heating condition comprises heating the particles and the decomposition fluid to about 200° C. to about 400° C.

25. A method of processing a material, the method comprising:
exposing a material in a disintegration vessel to a first disintegration fluid at a first pressure, the first disintegration fluid comprising supercritical argon, the first pressure being higher than a critical pressure of the first disintegration fluid;
disintegrating the material into particles by depressurizing the disintegration vessel from the first pressure to a second pressure, the second pressure being lower than the critical pressure of the first disintegration fluid;
exposing the particles to a decomposition fluid comprising supercritical argon and at least one additive; and
heating the particles and the decomposition fluid to a temperature sufficient to at least partially decompose a polymer present in at least some of the particles.

26. The method of claim 25,
wherein exposing the particles to the decomposition fluid and heating the particles are conducted in a decomposition vessel; and
wherein the method further comprises, prior to exposing the particles to the decomposition fluid and prior to heating the particles, transferring the particles from the disintegration vessel to the decomposition vessel.

27. (canceled)

28. The method of claim 25,
wherein disintegrating the material into the particles comprises disintegrating the material into the particles and at least one metal component; and
wherein the method further comprises, after disintegrating the material into the particles and the metal component, at least partially separating the metal component from the particles.

29.-33. (canceled)

34. The method of claim 25, wherein an average size of the particles is about 10 nm to about 2 mm.

35. The method of claim 25, wherein an average size of the particles is about 100 nm to about 1,000 nm.

36.-37. (canceled)

38. A mixture of reclaimed constituent components of a polymer produced by a method comprising the steps of:
providing particles comprising a polymer;
exposing the particles to a decomposition fluid comprising supercritical argon and at least one additive;
at least partially decomposing the polymer by subjecting the particles and the decomposition fluid to a heating condition.

39. (canceled)

40. The reclaimed constituent components of claim 38, wherein the polymer comprises at least one of epoxy resin, polycarbonate, and nylon.

41.-42. (canceled)

43. The method of claim 18, wherein the at least one supercritical noble gas comprises at least one of helium, neon, krypton, xenon, and radon.

44. The method of claim 18, wherein an average size of the particles is about 10 nm to about 2 mm.

45. The method of claim 18, wherein an average size of the particles is about 10 nm to about 1,000 nm.

46. The method of claim 18, wherein the additive comprises at least one of water, oxygen, sodium carbonate, NH₄OH, CO(NH₂)₂, an acid, an ionic liquid, methanol, ethanol, isopropyl alcohol, and 1-dodecanol.

47. The method of claim 18, wherein the polymer comprises at least one of epoxy resin, polycarbonate, and nylon.

48. The method of claim 18, wherein the step of at least partially decomposing the polymer comprises generating constituent components of the polymer.

49. The method of claim 18, wherein the constituent components of the polymer comprises at least one of bisphenol A, phenol, 6-amino caproic acid, and ε-caprolactam.
